(19) United States
(12) Patent Application Publication
(10) Pub. No.: US 2007/0181755 A1
(43) Pub. Date: Aug. 9, 2007

(54) Stand system for adjusting viewing angle of monitor

(76) Inventors: Sung I. Oh, West Covina, CA (US); Seung Gwon Jun, Suwon-Si (KR); Byung-Kil Kang, Seoul (KR)

Correspondence Address: SUNG I. OH, PROFESSIONAL LAW CORPORATION, 710 QUAIL VALLEY LANE, WEST COVINA, CA, 91791, US

(21) Appl. No.: 11/652,873

(22) Filed: Jan. 12, 2007

Related U.S. Application Data
(60) Provisional application No. 60/758,636, filed on Jan. 12, 2006.
(60) Provisional application No. 60/831,640, filed on Jul. 17, 2006.

(51) Int. Cl. F16M 11/02

(52) U.S. Cl. 248/176.1; 248/917

(57) ABSTRACT

A stand system tilts a monitor up or down. The stand system can move the monitor manually or through one or more motors. The stand system has a base and a neck. The an arc configuration that slides on one or more rollers. The base may be engaged with a mechanism that slides the base along the rollers following the arc configuration of the base. The gear mechanism may be coupled to a motor to slide the base on the roller through a motorized action.

### RELATED APPLICATIONS

This application claims priority to two provisional patent applications: (1) 60/758,636 filed Jan. 12, 2006; and (2) 60/831,640 filed Jul. 17, 2006, which are both incorporated by references.

### BACKGROUND OF THE INVENTION

1. Field of the Invention:

This invention is directed to a stand system that is capable of adjusting the viewing angle of a monitor and, in particular, capable of adjusting the tilting angle of the monitor.

2. Background of the Invention:

Flat panel monitors such as computer monitors, LCD TVs, plasma TVs, slim TVs, and the like (collectively referred to as “monitor(s)”) are becoming popular because of their slim appearance. Generally, the monitors are mounted onto a wall or either placed on the floor or placed on top of a table stand. Once a monitor is in position, a viewer generally adjusts the viewing angle of the monitor manually to a new viewing position so that the viewer may more comfortably view the monitor from a different location or to deflect a glare on the monitor away from the viewer. Manually adjusting the viewing angle of the monitor, however, can be inconvenient for the viewer. Accordingly, there is a need for a system that can adjust the viewing angle of a monitor more conveniently.

### INVENTION SUMMARY

This invention is directed to a stand system that tilts a monitor up or down. The stand system can move the monitor either manually or through one or more motors. The stand system has a base and a neck. The base has an arc configuration that slides on one or more rollers. The base may be engaged with a gear mechanism that slides the base along the rollers following the arc configuration of the base. The gear mechanism may be coupled to a motor to slide the base on the roller through a motorized action.

The neck has a proximal end and a distal end. The proximal end is adapted to couple the base, and the distal end is adapted to couple to back side of a monitor. The distal end of the neck may be sized and configured so that with the monitor coupled to the distal end, the distance between the center of the monitor and the proximal end of the neck may be similar to the radius of curvature of the base. However, it is within the scope of the invention to have the distance between the center of the monitor and the proximal end of the neck to be greater or less than the radius of curvature of the base. With the stand system described above, the torque required on the gear to move the base may be minimized because the moment of inertia due to the mass of the monitor is minimized as the monitor tilts. As such, even a heavy TV such as a plasma TV can be tilted substantially along its center of gravity to minimize the torque required on the gear.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a side view of a stand system in a first position.

FIG. 2 is a side view of the stand system according to FIG. 1 in a second position.

FIG. 3 is a side view of the stand system according to FIG. 1 in a third position.

FIG. 4 is a top view of the stand system illustrating a carousel adapted to swivel a monitor.

FIG. 5 is a side view of a distal end of a neck with a motorized housing for swiveling a monitor.

FIG. 6 is control diagram illustrating adjusting the viewing angle of a monitor through a remote control.

FIG. 7 is a side view of the stand system illustrating that a gear may engage a base at different locations.

FIG. 8 is a side view of an alternative stand system.

FIG. 9 is a rear perspective view of the stand system of FIG. 8.

### DETAILED DESCRIPTION OF THE INVENTION

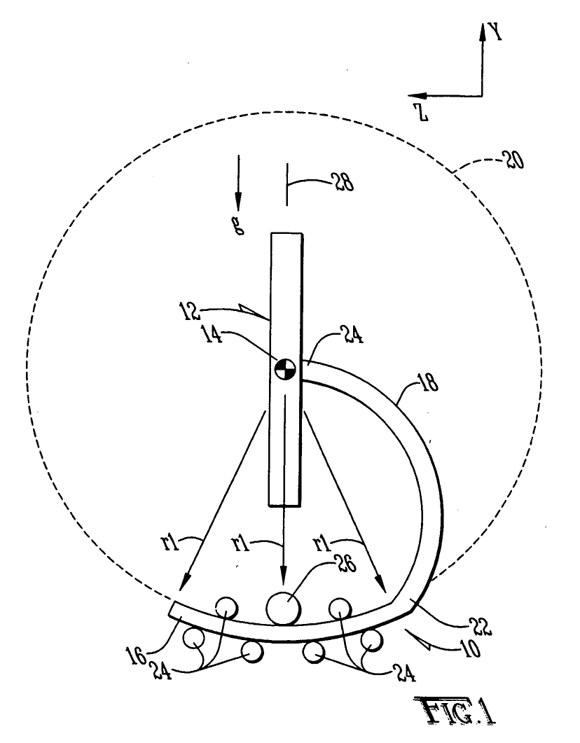

FIG. 1 shows a side view of a stand system 10, along the YZ plane, capable of tilting a monitor 12 substantially about its center axis 14. The stand system 10 includes a base 16 and a neck 18. The base 16 may have an arc configuration where the radius of curvature of the base has a radius r1. The radius r1 is the approximate distance between the center axis 14 and the base 16. Note that the partial circular hash lines are shown for illustrative purpose only to indicate that the base 16 may have an arc representing a portion of a circle 20 having a radius r1 where the center of the circle 20 is represented by the center axis 14.

The neck 18 may be provided between the monitor 12 and the base 16. The neck 18 may have a proximal end 22 and a distal end 24. The neck 18 may be sized so that the distance between the center axis 14 and the base 16 has a radius r1. Note that the neck may have a variety of configuration with the distance between the center axis 14 and the base 16 has a radius r1. The proximal end 22 of the neck 18 may be coupled to the base 16, and the distal end 24 of the neck 18 may be adapted to couple to the monitor 12. The location of the distal end 24 may be near the center of the circle 20 so that once the monitor 12 is attached to the distal end 24, the center axis 14 of the monitor 12 is substantially along the focal point of the arc formed by the base 16.

The base 16 may be supported by one or more rollers 24 to allow the base 16 to move substantially along the arc formed by the circle 20. The base 16 may be engaged with a gear 26 that rotates to cause the base 16 to move along the path formed by the circle 20. The gear 26 may be driven either manually or through a motor. For instance, a counter-clockwise rotation of the gear 26 may cause the base 16 to move in counter-clockwise direction; and, conversely, clockwise rotation of the gear 26 may cause the base 16 to move in clockwise direction.

The center of gravity of different monitors may differ depending on the placement of their internal components. Assuming, however, that the center axis 14 of the monitor 12 substantially represents the center of gravity of the monitor 12, the monitor 12 may pivot about its center of gravity as the base 16 moves. This allows the stand system 10 to tilt the monitor 12 substantially along its center of gravity, in the YZ plane, so that moment of inertia due to the mass of the monitor 12 may be minimized.

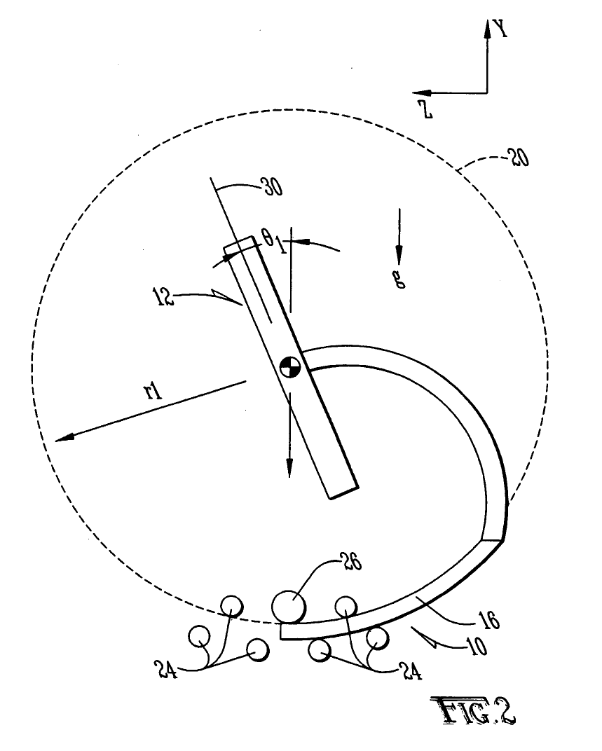

FIG. 1 shows the monitor 12 in a first position 28 that is substantially along the direction of gravitation force. FIG. 2 shows the mount 12 in a second position 30 that is in a titled down position. In this regard, the gear 26 may rotate in the counter-clockwise direction to move the base 16 in the counter-clockwise direction along the path defined by the circle 20, which in turn tilts the monitor 12 downwards about its center of gravity. Note that the downward tilting angle Ø1 may be increased or decreased by increasing or decreasing the radius r1, respectively, while maintaining the same circumference length of the base 16.

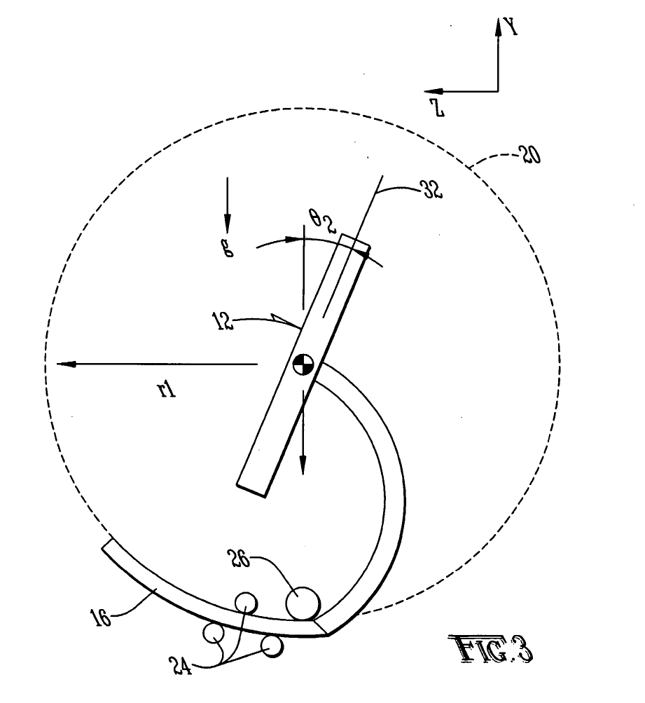

FIG. 3 shows the mount 12 in a third position 32 that is in a tilted up position. In this regard, the gear 26 may rotate in the clockwise direction to move the base 16 in the clockwise direction along the path defined by the circle 20, which in turn tilts the monitor 12 upwards about its center of gravity. Note that in the three positions 28, 30, and 32, the center of gravity of the monitor 12 is substantially maintained in the same position so that the weight of the monitor 12 may be supported by the rollers 24. In addition, torque required on the gear 26 to move the base 16 may be minimized with the moment of inertia due to the mass of the panel 12 being minimized as the monitor tilts. With the stand system 10 described above, even a heavy TV such as a plasma TV can be tilted substantially along its center of gravity to minimize the torque required on the gear 26.

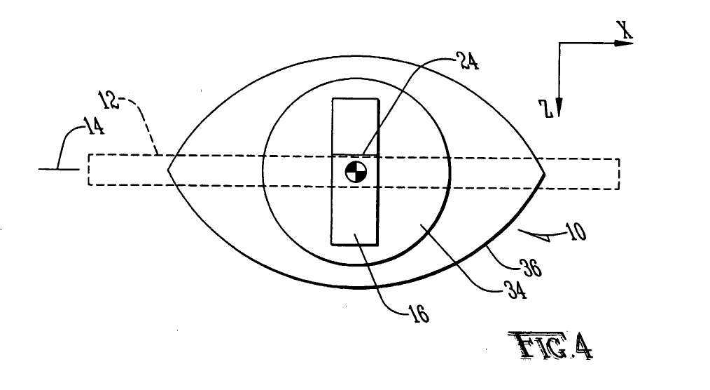

FIG. 4 shows a top view of the stand system 10 along the XZ plane. The stand system 10 may include a carousel 34 adapted to rotate relative to a base plate 36. The base plate 36 may be adapted to sit on the floor or on top of a table. The carousel 34 may rotate either clockwise or counter-clockwise direction along the XZ plane. The carousel 34 may rotate either manually or through a motor. The base 16 may be coupled to the carousel 34 so that as the carousel 34 rotates, the monitor 12 may be rotated or swivel about the XZ plane. Note that the distal end 24 of the neck 18 may couple to the back side of the monitor 12 so that the center of gravity of the monitor 12 is substantially along the center of the carousel 34 so that the monitor 12 may substantially swivel about its center of gravity.

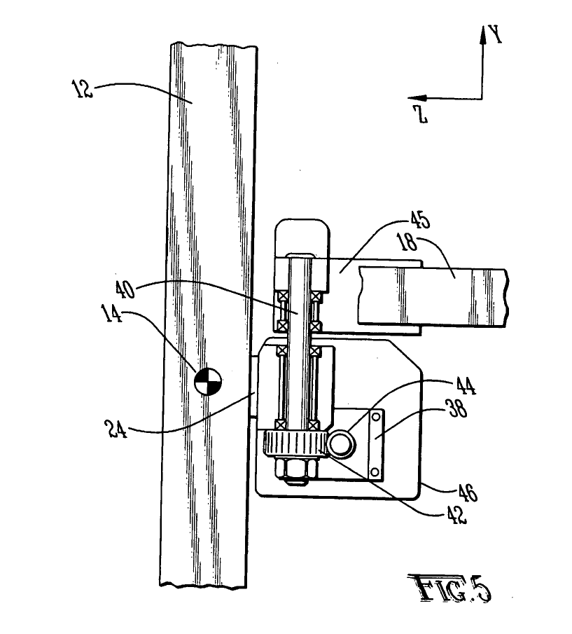

FIG. 5 shows an enlarge view of the distal end of the neck 18 along the YZ plane. In this embodiment, a motor 38 may be provided on the distal end 24 of the neck 18 to swivel the monitor 12 along the XZ plane. The distal end 24 of the neck 18 extends from a housing 46 that includes a shaft 40 that is coupled to the neck 18. The housing includes a wheel gear 42 that is coupled to the shaft 40. The motor 38 has a motor gear 44 that is engaged with the wheel gear 42. As the motor gear 44 rotates, the housing 46 rotates about the shaft 40 or swivels about the XZ plane, which in turn swivels the monitor 12 around the shaft 40 or along the XZ plane.

The distal end 24 may also be coupled to a second housing 45 adapted to receive a portion of the neck 18. This allows the distal end 24 to be adjustable along the Z-axis relative to the neck 18 so that the center axis 14 of the monitor 12 may be the focal point of the arc formed by the base 16. With the embodiments shown in FIGS. 4 and 5, the monitor 12 may be swiveled either through the carousel 34 or the housing 46.

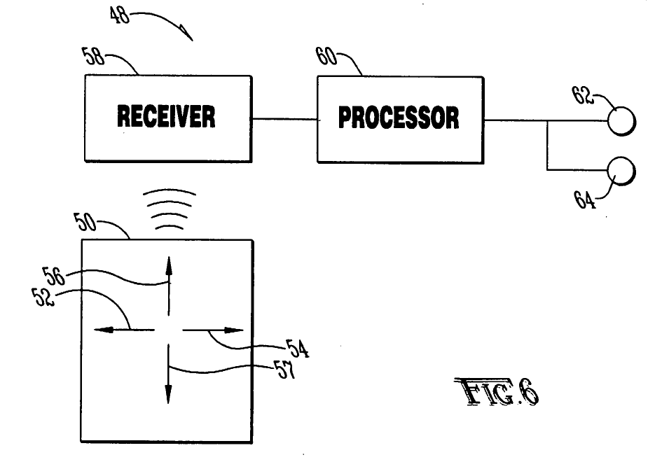

FIG. 6 shows a control diagram 48 for adjusting the viewing angle of the monitor 12 through a remote control 50. The remote control 50 may have swivel left button 52, swivel right button 54, tilt up button 56, and a tilt down button 57. The control diagram 48 includes a receiver 58 that receives the control signal from the remote control 50. The receiver 58 sends the control signal to a processor 60, which then controls the motors 62 and 64 to tilt and/or swivel the monitor 12. For instance, the motor 62 may be linked to the gear 26 to tilt the monitor up by rotating the gear in the clockwise direction or tilt the monitor down by rotating the gear 26 in a counter-clockwise direction. The motor 64 may be linked to the carousel 34 to swivel the carousel 34 either in clockwise or counter-clockwise direction to swivel the monitor. In reference to FIG. 5 where the monitor is swiveled through the housing 46, the motor 64 may be the motor 38 discussed above.

With the remote control 50, a user can adjust the viewing angle of the monitor 12 by pushing one or more of the buttons 52, 54, 56, and 57. For instance, a viewer can push the tilt down button 57 to adjust the viewing angle of the monitor 12 towards the second position 30; and push the tilt up button 56 to adjust the viewing angle of the monitor 12 towards the third position 32.

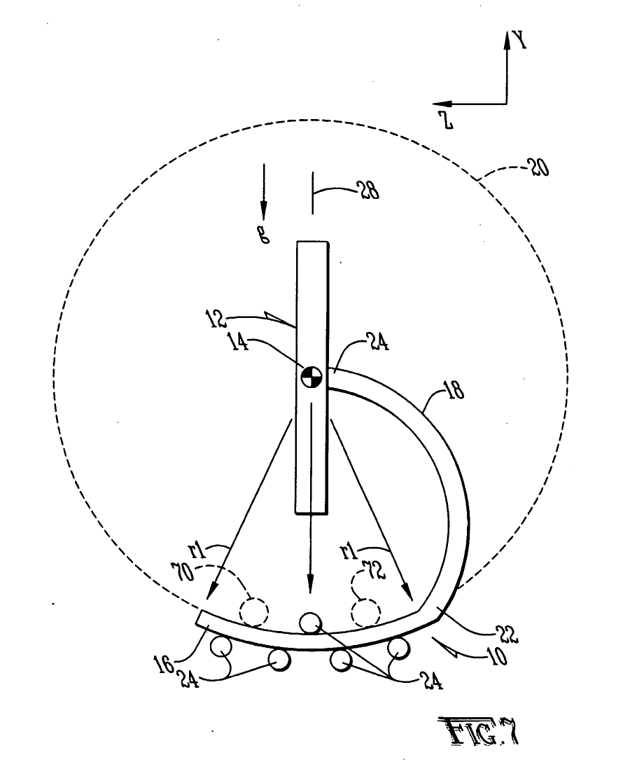

FIG. 7 shows that the gear 26 may be located at different locations. For instance, the gear 26 may be located at a first position 70 and/or a second position 72. By locating the gear 26 in the first position 70, which is in the front side of the monitor 12, the stand system 10 may have greater tilt angle in the clockwise direction than in the counter-clockwise direction. Conversely, by locating the gear 26 in the second position 72, which is in the rear side of the monitor 12, the stand system 10 may have greater tilt angle in the counter-clockwise direction than in the clockwise direction. In reference, to FIG. 1, by having the gear 26 located at the center of the base 16, the tilt angle is same in either direction. Note that a gear that is mechanically coupled to a motor may be located on the top side of the base 16 and/or on the bottom side of the base 16.

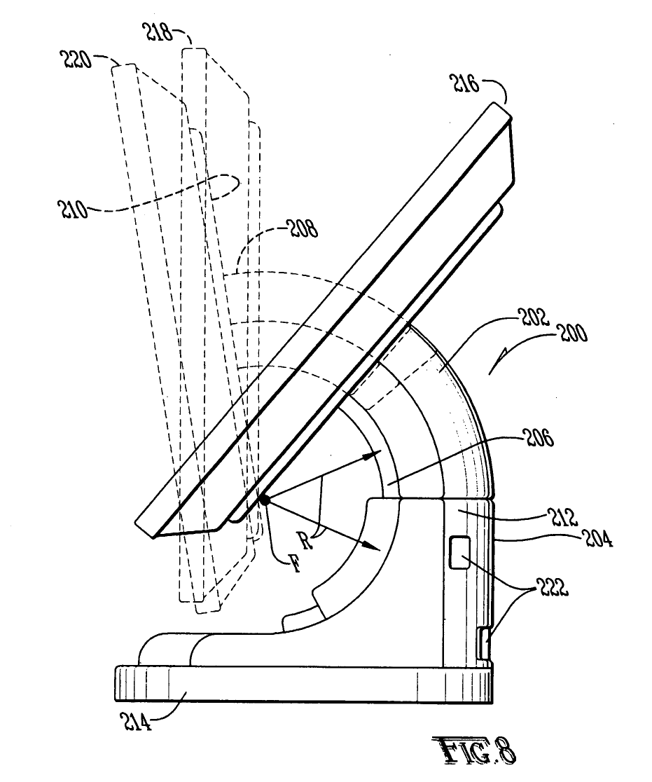

FIG. 8 shows a stand system 200 having a first portion 202 and a second portion 204. The first portion 202 has a proximal end 206 that is adapted to extend and retract relative to the second portion 204 in an arcing manner. The distal end 208 of the first portion is adapted to couple to the back side of a monitor 210. The second portion 204 has a neck 212 adapted to receive the proximal end 206 of the first portion 202. The second portion 204 has a base 214 adapted to sit on top of a table or floor, or adapted to attached to a ceiling. FIG. 8 shows the stand system 200 in a first position 216 where the monitor is tilted upwards; a second position 218 where the monitor is substantially in an upright position; and a third position 220 where the monitor is tilted downwards. As the first portion 202 extends from the second portion 204, the first portion 202 may be shaped in a semi-circular configuration to form an arc having a radius “R” about the focal point “F.”

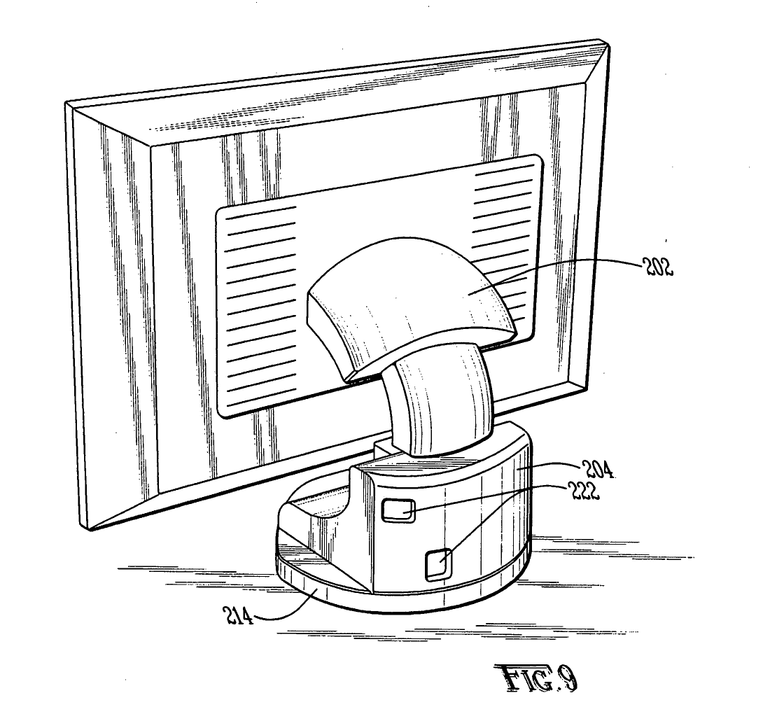

The second portion 204 may have one or more openings 222 to allow cables and cords to pass therethrough and couple to the inputs in the monitor 210 to provide audio and video signals and power to the monitor. FIG. 9 shows a rear perspective view of the stand system 200 in the second position 218. The second portion 204 has two openings 222 to allow audio and video wires and power cords to pass therethrough and connect to the input sockets on the monitor. As discussed above, the second portion 204 may swivel relative to the base 214.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A stand system adapted to tilt a monitor, the stand system comprising:
a base having a curvature configuration with a radius of curvature;
a neck having a proximal end and a distal end, the distal end adapted to couple to a back side of the monitor, and the proximal end adapted to couple to the base; and
a plurality of rollers adapted to support the base to slide the base along its curvature configuration to tilt the monitor in clockwise or counter-clockwise direction.

2. The stand system according to claim 1, where a distance between the proximal end and the distal end of the neck is similar to the radius of curvature of the base.

3. The stand system according to claim 1, where the distal end adapted to couple to the back side of the monitor so that a distance between a center of the monitor and the distal end of the neck is similar to the radius of curvature of the base.

4. The stand system according to claim 1, where the distal end adapted to couple to the back side of the monitor so that a distance between a center of the monitor and the distal end of the neck is greater than the radius of curvature of the base.

5. The stand system according to claim 1, including a carrousel, the base coupled to the carrousel to swivel the monitor.

6. The stand system according to claim 1, including a gear engaged with the base to slide the base along the rollers.

7. The stand system according to claim 2, including a motor engaged with the gear to slide the base along the rollers based on motorized action.

8. The stand system according to claim 6, where the gear is located between the center of the base and the proximal end of the neck.

9. A method of tilting a monitor having a center of gravity, the method comprising:
supporting a monitor from a table; and
tilting a monitor substantially along its center of gravity.
